(19) United States
(12) Patent Application Publication
(10) Pub. No.: US 2026/0301620 A1
(43) Pub. Date: Oct. 1, 2026

(54) COMMUNICATION METHOD, TOUCH DISPLAY MODULE, CHIP, DEVICE, AND ACTIVE STYLUS

(71) Applicant: Chipone Technology (Beijing) Co., Ltd., Beijing (CN)

(72) Inventors: Chia Hao HSU, Beijing (CN); Chih Ying LIN, Beijing (CN)

(73) Assignee: Chipone Technology (Beijing) Co., Ltd., Beijing, CN (CN)

(21) Appl. No.: 19/489,408

(22) PCT Filed: Aug. 30, 2023
(86) PCT No.: PCT/CN2023/115775

§ 371 Date: Dec. 2, 2025

(30) Foreign Application Priority Data
Jun. 2, 2023 (CN) 202310647032.X

(51) Int. Cl. G09G 3/00; G09G 3/36

(52) U.S. Cl. CPC G09G 3/006; G09G 3/3648; G09G 2320/0626; G09G 2380/10

(57) ABSTRACT

The present disclosure relates to a display driving method, a display driving chip, and a display device. The display driving method includes: determining whether an abnormal signal is detected in feedback; if so, switching to a common voltage regulation display mode until the abnormal signal disappears, wherein, in the common voltage regulation display mode, the display grayscale of the pixel circuit is controlled by the common voltage, so that an alarm image is displayed. Compared to display methods controlled by the source driving circuit, the approach according to the present disclosure can significantly reduce the complexity of control processes and the number of required memory units.

The present application claims priority to Chinese patent application No. 202310647032.X, filed on Jun. 2, 2023, titled “DISPLAY DRIVING METHOD, DISPLAY DRIVING CHIP, AND DISPLAY DEVICE,” the content of which is incorporated herein by reference, including the entire disclosure, claims, drawings, and abstract.

### TECHNICAL FIELD

The present disclosure relates to a field of display technology, and more particularly, to a display driving method, a display driving chip, and a display device.

### BACKGROUND

Liquid crystal display (LCD) panels are in widespread use and have been applied in various aspects of life, including in-vehicle display systems.

In in-vehicle display systems, it is crucial to have a mechanism that can alert the driver in the event of a vehicle accident, allowing the driver to adequately respond to various situations and prevent the accident from escalating. Typically, when a driving accident occurs, the display module may already be damaged, and most functions of the display driving IC (integrated circuit) may no longer work properly. At this time, a simple, low-power display method is needed to allow the display screen to generate a corresponding alarm image.

### SUMMARY OF THE DISCLOSURE

In view of the above issues, an objective of the present disclosure is to provide a display driving method, a display driving chip, and a display device, thereby achieving a simple, low-power display solution that allows a display screen to generate a corresponding alarm image.

According to one aspect of the present disclosure, a display driving method is provided, and includes: determining whether an abnormal signal is detected in feedback; if the abnormal signal is detected, switching to a common voltage regulation display mode until the abnormal signal disappears, wherein, in the common voltage regulation display mode, a display grayscale of the pixel circuit is controlled by a common voltage, so that an alarm image is displayed.

Optionally, the step of switching to the common voltage regulation display mode until the abnormal signal disappears includes: adjusting a common voltage of a pixel array in accordance with a display image; providing a fixed source driving voltage to the pixel array.

Optionally, the step of adjusting the common voltage of the pixel array in accordance with the display image includes: dividing common electrodes into a plurality of regions, and controlling bias voltages of the common electrodes within different ones of the plurality of regions.

Optionally, the number of levels of display grayscale of the pixel circuit corresponds to the number of predetermined values of the bias voltages of the common electrodes, and the predetermined values of the bias voltages of the common electrodes at least include a first predetermined value corresponding to display grayscale of a bright image, and a second predetermined value corresponding to display grayscale of a dark image.

Optionally, a voltage value of the fixed source driving voltage is the same as the first predetermined value.

Optionally, the predetermined values of the bias voltages of the common electrodes further include several third predetermined values between the first predetermined value and the second predetermined value.

Optionally, voltage values of the fixed source driving voltage include multiple fixed values that respectively correspond to the first predetermined value and the several third predetermined values.

Optionally, the abnormal signal is a feedback signal received when a failure occurs in a memory unit in the display driving circuit.

Optionally, when the bias voltages of the common electrodes of pixels that correspond to the alarm image are set to the first predetermined value, a bright alarm image is displayed, and when the bias voltages of the common electrodes of pixels that correspond to the alarm image are set to the second predetermined value, a dark alarm image is displayed.

According to another aspect of the present disclosure, a display driving chip is provided for executing any of the display driving methods described above.

According to another aspect of the present disclosure, a display device is provided, and includes: a pixel array, including a plurality of pixel units arranged in rows and columns, and the aforementioned display driving chip, for providing a scanning signal to a corresponding row of the plurality of pixel units in the pixel array, providing a control voltage to a corresponding column of the plurality of pixel units, and switching to a common voltage regulation display mode when the abnormal signal is detected in feedback, until the abnormal signal disappears.

The display driving method according to the present disclosure is suitable for application in an LCD panel having an array-type architecture. By changing the common voltage in the LCD panel, a voltage difference between the source driving voltages provided to the pixels by the source driving circuit is altered, allowing the LCD panel to display a specific image when the source driving circuit outputs a fixed voltage. Compared to display methods controlled by the source driving circuit, the solution according to the present disclosure can significantly reduce the complexity of control processes and the number of required memory units.

### BRIEF DESCRIPTION OF THE DRAWINGS

The above and other objectives, features, and advantages of the present disclosure will become more apparent from the following description of embodiments of the present disclosure with reference to the accompanying drawings, in which:

FIGS. 1 and 2 respectively show a schematic structural diagram and an equivalent circuit diagram of a liquid crystal display device according to an embodiment of the present disclosure.

FIG. 3 shows a flowchart of a display driving method under an abnormal condition according to an embodiment of the present disclosure.

FIG. 4 shows a flowchart of specific steps in the display driving method under abnormal conditions according to an embodiment of the present disclosure.

FIG. 5 shows a schematic diagram of common electrode partitioning in a display panel according to an embodiment of the present disclosure.

FIG. 6 shows a schematic diagram of a display image in a display panel according to an embodiment of the present disclosure.

### DETAILED DESCRIPTION

Various embodiments of the present disclosure will be described in more detail below with reference to the accompanying drawings. In the drawings, the same elements or units are denoted by the same or similar reference numerals. For clarity, the various parts in the drawings are not drawn to scale.

It should be understood that, in the following description, “circuit” may include a single or multiple combined hardware circuits, programmable circuits, state machine circuits, and/or elements capable of storing instructions executed by programmable circuits. When an element or circuit is said to be “connected to” another element or said to be “connected between” two nodes, it may be directly coupled or connected to another element or there may be intermediate elements, and the connection between elements may be physical, logical, or a combination thereof. Conversely, when an element is said to be “directly coupled to” or “directly connected to” another element, it means that there are no intermediate elements between them.

Furthermore, certain terms are used in this patent specification and claims to refer to specific components. Those skilled in the art should understand that hardware manufacturers may use different terms to refer to the same component. This patent specification and claims do not distinguish components by name but by the differences in their functions.

Additionally, it should be noted that, in this document, relational terms such as first and second are used solely to distinguish one entity or operation from another entity or operation and do not necessarily require or imply any actual relationship or order between these entities or operations. Moreover, the terms “comprising,” “including,” or any other variations thereof are intended to cover non-exclusive inclusion, so that a process, method, article, or device that includes a series of elements not only includes those elements but also includes other elements not explicitly listed, or elements inherent to such a process, method, article, or device. Without further limitations, an element defined by the phrase “comprising a . . . ” does not exclude the presence of additional identical elements in the process, method, article, or device that includes the element.

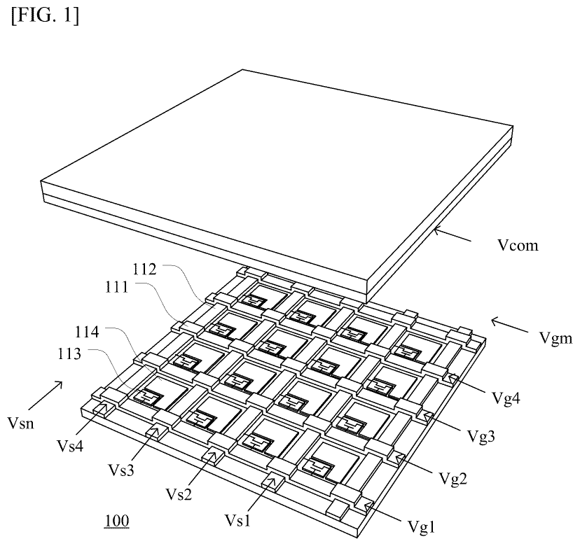

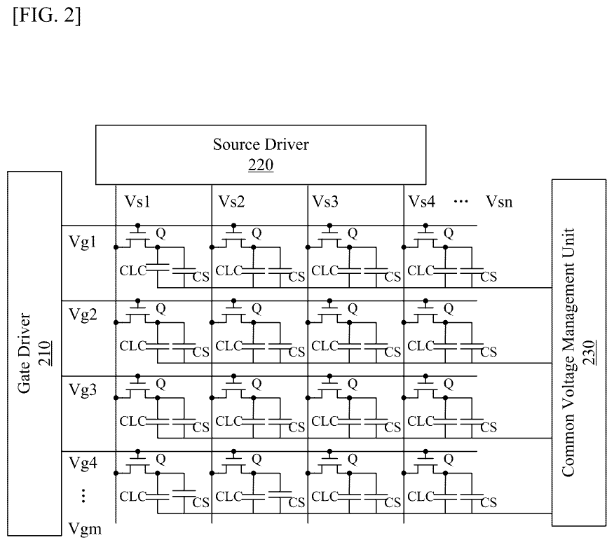

FIGS. 1 and 2 respectively show a schematic structural diagram and an equivalent circuit diagram of a liquid crystal display device according to an embodiment of the present disclosure.

As shown in FIGS. 1 and 2, the liquid crystal display device 100 includes a first glass substrate 110 and a second glass substrate 210, with the first surface of the first glass substrate 110 facing the first surface of the second glass substrate 210. On the first surface of the first glass substrate 110, multiple gate scanning lines 111 and multiple source data lines 112 are formed intersecting each other, with selection thin-film transistors 113 and pixel electrodes 114 arranged at the intersections. A common electrode 211 is formed on the first surface of the second glass substrate 210. A liquid crystal layer is included between the pixel electrode 114 and the common electrode 211, which can be equivalent to a pixel capacitor CLC. The gate scanning line 111 gates the thin-film transistor 113, and the source data line 112 applies a voltage corresponding to the grayscale to the pixel capacitor CLC, thereby changing the orientation of the liquid crystal molecules to achieve the brightness of the corresponding grayscale. To maintain the voltage between pixel update cycles, the pixel capacitor CLC can be connected in parallel with a storage capacitor Cs to obtain a longer hold time.

The display driving circuit in the display device 100 includes: a gate driver 210, connected to multiple gate scanning lines 111, for providing gate voltages Vg1 to Vgm, and providing a fixed gate voltage in the event of an abnormal condition; a source driver 220, connected to multiple source data lines 112, for providing source voltages Vs1 to Vsn, and a common voltage management unit 230, for providing predetermined common voltages to each common electrode in the event of an abnormal condition.

In the display device of the present disclosure, the display driving chip is used to provide scanning signals to the pixel units arranged in rows in the pixel array, provide control voltages to the pixel units arranged in columns, and switch to a common voltage regulation display mode when an abnormal signal is detected in feedback, until the abnormal signal disappears, wherein the common voltage regulation display mode will be introduced later.

The aforementioned display driving circuit can be a standalone display driving chip, and it can also be integrated with touch control to form a TDDIC (Touch and Display Driver Integration Circuit).

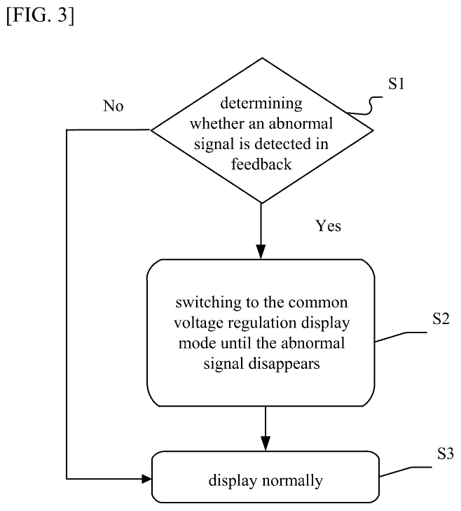

FIG. 3 shows a flowchart of a display driving method under an abnormal condition according to an embodiment of the present disclosure.

As shown in FIG. 3, when a vehicle accident occurs, most functions of the display driving chip may no longer work properly. At this time, under the abnormal condition, the display driving chip will execute the aforementioned display driving method, which specifically includes the following steps:

Step S1: determine whether an abnormal signal is detected in feedback.

In step S1, it is determined whether a feedback abnormal signal is detected. If so, step S2 is executed; if not, step S3 is executed. The abnormal condition can refer to various manually preset conditions, such as a failure in the memory unit of the display driving circuit, a failure in the source control circuit, etc.

Step S2: switch to the common voltage regulation display mode until the abnormal signal disappears.

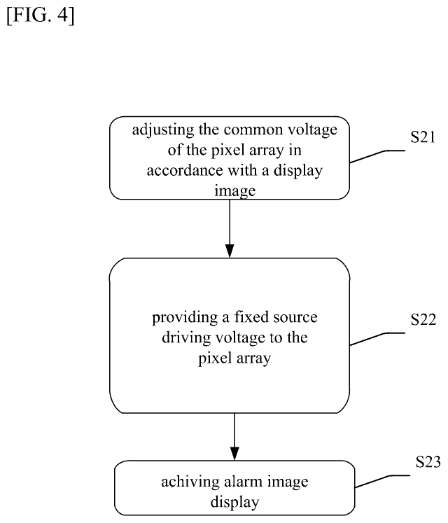

FIG. 4 shows a flowchart of specific steps in the display driving method under an abnormal condition according to an embodiment of the present disclosure. In the common voltage regulation display mode, the display grayscale of the pixel circuit is controlled by the common voltage, so that an alarm image is displayed. Switching to the common voltage regulation display mode can specifically include:

Step S21: adjust the common voltage of the pixel array in accordance with a display image.

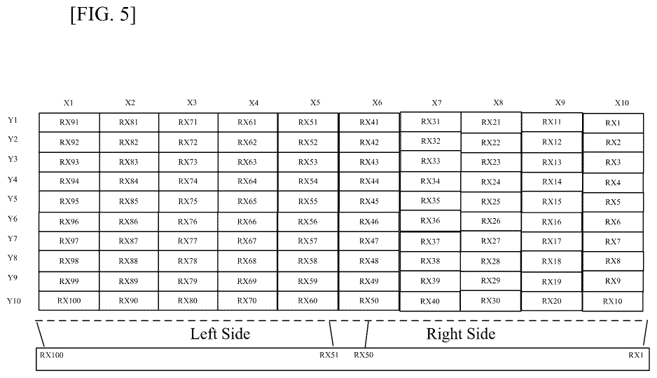

FIG. 5 shows a schematic diagram of common electrode partitioning in a display panel according to an embodiment of the present disclosure. As shown in FIG. 5, the common electrodes in the display panel can be divided into two regions, such as the left region and the right region in the drawings (corresponding to Left Side and Right Side), and different bias adjustment strategies (corresponding to, for example, the bright image and its opposite dark image described below) can be adopted for the common electrodes in different regions.

Specifically, for a 10*10 pixel array of common electrodes, the common electrodes can be divided into one region including the common electrodes RX1-RX50, and another region including the common electrodes RX51-RX100, and then partition display can be performed. When adjusting the bias voltages of the common electrodes, within a region, the display grayscale can be set into two levels (black/white), three levels, etc., related to the voltage output precision of the common electrodes, i.e., the level number of display grayscale of the pixel circuit corresponds to the number of predetermined values of the bias voltages of the common electrodes. When the display grayscale is set into two levels, the bias voltages of the common electrode within the region have two predetermined values. The pixels corresponding to the common electrode with the bias voltage of the first predetermined value are configured to display a bright image during display driving process, while the pixels corresponding to the common electrodes with the bias voltage of the second predetermined value are configured to display a dark image during display driving process. In one embodiment, the first predetermined value is, for example, 5V, and the second predetermined value is, for example, 0V.

It should be additionally noted that the pixel array is only an example and can be of other size. The above example is achieved based on a two-level display grayscale. When the display grayscale has three levels, the bias voltages of the common electrodes within a region further include third predetermined values, which are, for example, 0V, 2.5V, and 5V, that is, in addition to the first predetermined value and the second predetermined value, several third predetermined values are included. Other numbers of display grayscale levels follow this analogy.

Step S22: provide a fixed source driving voltage to the pixel array.

In step S22, the source driving circuit provides a fixed driving voltage. When the display grayscale has two levels, the voltage value of the fixed source driving voltage is the same as the first predetermined value; when the display grayscale has more levels, the voltage values of the fixed source driving voltage include multiple fixed values that correspond to the first predetermined value and the several third predetermined values.

Step S23: achieve alarm image display control.

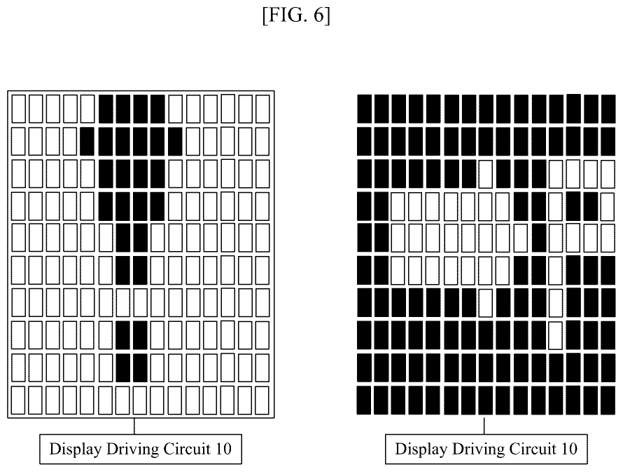

FIG. 6 shows a schematic diagram of a display image in a display panel according to an embodiment of the present disclosure. In step S23, achieving alarm image display control, can be as shown in FIG. 6. In one embodiment, the bias voltage of the common electrode of a pixel that corresponds to an image to be displayed is set to a voltage for displaying a dark image, i.e., the second predetermined value (the displayed image corresponds to the figure shown on the left side of FIG. 6), and a dark alarm image is displayed. In another embodiment, the bias voltage of the common electrode of a pixel that corresponds to the image to be displayed is set to a voltage for displaying a bright image, i.e., the first predetermined value (the displayed image corresponds to the figure shown on the right side of FIG. 6), and a bright alarm image is displayed. However, the present application does not limit this.

Step S3: display normally.

In step S3, when the aforementioned abnormal signal disappears, the display driving circuit displays normally, and the source driving circuit provides data voltages corresponding to the display grayscale levels.

The present disclosure is suitable for application in array-type architecture LCD panels. By changing the common voltage in the LCD panel, a voltage difference between the source driving voltages provided to the pixels by the source driving circuit is altered, allowing the LCD panel to display a specific image when the source driving circuit outputs a fixed voltage. Compared to display methods controlled by the source driving circuit, this can significantly reduce the complexity of control processes and the number of required memory units. The display resolution will be determined based on the number of the regions of the common electrodes, and the display grayscale can have two levels (black/white), three levels, or others.

The present disclosure is applicable to various fields, especially in-vehicle or industrial control display ICs. When an emergency occurs, if the display module is already abnormal, it can switch to a simple display mechanism to display a preset alarm image, guiding the user to take a correct action and avoiding confusion due to abnormal image display, thereby preserving valuable emergency response time.

It should be noted that those skilled in the art can understand that the terms “during,” “when,” and “when . . . then” used in this document related to circuit operation are not strict terms indicating actions that occur immediately at the start of an action, but there may be some small but reasonable one or more delays between them and the reaction actions initiated by the start action, such as various transmission delays, etc. The terms “approximately” or “substantially” used in this document mean that the element value has a parameter that is expected to be close to the declared value or position. However, as is well known in the art, there are always slight deviations that make it difficult for the value or position to be strictly the declared value. The art has appropriately determined that at least ten percent (10%) (for semiconductor doping concentrations, at least twenty percent (20%)) deviation is a reasonable deviation from the accurately described ideal target. When used in conjunction with signal states, the actual voltage value or logic state (e.g., “1” or “0”) of the signal depends on whether positive logic or negative logic is used.

According to the embodiments of the present disclosure as described above, these embodiments do not exhaustively describe all details, nor do they limit the disclosure to the specific embodiments. Obviously, many modifications and variations can be made based on the above description. The specification selects and specifically describes these embodiments to better explain the principles and practical applications of the present disclosure, enabling those skilled in the art to better utilize the present disclosure and modifications based on the present disclosure. The scope of protection of the present disclosure should be defined by the claims and their equivalents.

1. A display driving method, comprising:
determining whether an abnormal signal is detected in feedback;
if the abnormal signal is detected, switching to a common voltage regulation display mode until the abnormal signal disappears,
wherein, in the common voltage regulation display mode, display grayscale of a pixel circuit is controlled by a common voltage, so that an alarm image is displayed.

2. The display driving method according to claim 1, wherein the step of switching to the common voltage regulation display mode until the abnormal signal disappears comprises:
adjusting a common voltage of a pixel array in accordance with a display image;
providing a fixed source driving voltage to the pixel array.

3. The display driving method according to claim 2, wherein the step of adjusting the common voltage of the pixel array in accordance with the display image comprises: dividing common electrodes into a plurality of regions, and controlling bias voltages of the common electrodes within different ones of the plurality of regions.

4. The display driving method according to claim 3, wherein the number of levels of the display grayscale of the pixel circuit corresponds to the number of predetermined values of the bias voltages of the common electrodes, and the predetermined values of the bias voltages of the common electrodes at least include a first predetermined value corresponding to display grayscale of a bright image, and a second predetermined value corresponding to display grayscale of a dark image.

5. The display driving method according to claim 4, wherein a voltage value of the fixed source driving voltage is same as the first predetermined value.

6. The display driving method according to claim 4, wherein the predetermined values of the bias voltages of the common electrodes further include several third predetermined values between the first predetermined value and the second predetermined value.

7. The display driving method according to claim 6, wherein voltage values of the fixed source driving voltage include a plurality of fixed values that respectively correspond to the first predetermined value and the several third predetermined values.

8. The display driving method according to claim 3, the abnormal signal is a feedback signal received when a failure occurs in a memory unit in the display driving circuit.

9. The display driving method according to claim 2, when the bias voltages of the common electrodes of pixels corresponding to the alarm image are set to the first predetermined value, a bright alarm image is displayed, and when the bias voltages of the common electrodes of pixels corresponding to the alarm image are set to the second predetermined value, a dark alarm image is displayed.

10. A display driving chip, for executing the display driving method according to claim 1.

11. A display device, comprising:
a pixel array, including a plurality of pixel units arranged in rows and columns,
the display driving chip according to claim 10, for providing a scanning signal to a corresponding row of the plurality of pixel units in the pixel array, providing a control voltage to a corresponding column of the plurality of pixel units, and switching to the common voltage regulation display mode when the abnormal signal is detected in feedback, until the abnormal signal disappears.
